(19) United States
(12) Patent Application Publication
(10) Pub. No.: US 2011/0100058 A1
(43) Pub. Date: May 5, 2011

(54) FORMATION OF GLASS BUMPS WITH INCREASED HEIGHT USING THERMAL ANNEALING

(76) Inventors: James Edward Dickinson, JR., Corning, NY (US); Richard Robert Grzybowski, Corning, NY (US); Daniel R. Harvey, Bath, NY (US); Stephan Lvovich Logunov, Corning, NY (US); Alexander Mikhailovich Streltsov, Corning, NY (US)

(21) Appl. No.: 12/610,026

(22) Filed: Oct. 30, 2009

(51) Int. Cl. C03B 25/00

(52) U.S. Cl. 65/104

(57) ABSTRACT

The disclosure teaches methods of forming at least one bump in a glass substrate having a surface and a body portion. The method includes performing a first irradiation of a portion of the glass substrate to form in the glass surface the at least one bump having bump height. The method also includes performing thermal annealing of at least a portion of the glass substrate that includes the first irradiated portion. The method then includes performing a second irradiation of the bump to increase the bump height.

### FIELD

This disclosure relates to the formation of bumps on glass using laser irradiation, and in particular relates to methods for forming such bumps having increased height through the use of thermal annealing.

### BACKGROUND

The effect of glass swelling when glass is locally irradiated with a laser is known. Bumps, 100 micrometers or taller, can be formed by heating a glass surface with an infrared laser beam having sufficient energy. References that describe the formation of bumps on glass using laser irradiation include U.S. Pat. Nos. 7,480,432 and 7,505,650, which patents are incorporated by reference herein, and the article by Grzybowski et al., entitled “Extraordinary laser-induced swelling of oxide glasses,” Opt. Express 17, 5058-5068 (2009), which article is incorporated by reference herein.

When fabricating bumps with a laser beam incident upon on a glass surface, there is the maximum achievable height based on the glass composition and the laser-irradiation conditions. Due to localized changes in the glass structure, there is a saturation effect that limits the bump heights to approximately 10% to 13% of the glass thickness. For example, the maximum bump height is nominally 100 μm to 130 μm for a 1-mm thick glass substrate. Thus, for a given glass selection, greater bump heights have not been achievable relative to the substrate thickness because of the glass saturation effect.

Yet, many applications would benefit from the formation of bumps with greater bump heights relative to the substrate thickness. One such application is window spacers for insulating windows, wherein the glass bumps serve to stand off adjacent window panes to create an insulating space. Increasing the size of the space without increasing the pane thickness would increase the insulating properties of the window while maintaining cost.

It is therefore desirable to find laser-based methods of forming bumps on glass with bump heights that exceed those associated with the glass-saturation-effect limits.

### SUMMARY OF THE DISCLOSURE

An aspect of the disclosure is a method of forming at least one bump on a surface of a glass substrate. The method includes performing a local irradiation of the glass substrate to form the at least one bump having an initial height. The method also includes thermally annealing at least a portion of the glass substrate to a temperature and for a duration that reduces or relieves laser-induced stress in the glass substrate. The method further includes increasing the bump height by irradiating the bump.

Another aspect of the disclosure is a method of forming a bump in a glass substrate having a surface and a body portion. The method includes performing a first irradiation of a portion of the glass substrate to form the bump in the glass surface, with the bump having a first height. The method also includes performing a first thermal annealing of the first irradiated portion. The method also includes performing a second irradiation of at least part of the first irradiated portion to increase the height of the bump to a second height greater than the first height.

Another aspect of the disclosure is method of forming at least one bump on a surface of a glass substrate. The method includes irradiating a first portion of the glass substrate with a first laser beam to form at least one bump having a first height H1. The method also includes thermally annealing at least a portion of the glass substrate to reduce or relieve glass stress formed during the irradiating. The method also includes irradiating the at least one bump with a second laser beam to increase the bump height to a second height H2>H1.

Additional features and advantages of the disclosure will be set forth in the detailed description which follows, and in part will be readily apparent to those skilled in the art from that description or recognized by practicing the disclosure as described herein, including the detailed description which follows, the claims, as well as the appended drawings.

It is to be understood that both the foregoing general description and the following detailed description present embodiments of the disclosure, and are intended to provide an overview or framework for understanding the nature and character of the disclosure as it is claimed. The accompanying drawings are included to provide a further understanding of the disclosure, and are incorporated into and constitute a part of this specification. The drawings illustrate various embodiments of the disclosure, and together with the description serve to explain the principles and operations of the disclosure.

### BRIEF DESCRIPTION OF TILE DRAWINGS

FIG. 1 is a schematic diagram of an example laser irradiation system used to form bumps on glass and to optionally perform laser-based thermal annealing of the bumps;

FIG. 2 is a schematic close-up, cross-sectional diagram of a glass substrate and a laser beam incident thereon, illustrating an initial bump formation step;

FIG. 3 is similar to FIG. 2 but showing the formation of a glass bump of height H1 as a result of the initial laser irradiation;

FIG. 4 is a perspective view of the glass substrate of FIG. 3 showing the initially formed glass bump;

FIG. 5 is a schematic diagram of the glass substrate of FIG. 3 as placed in an oven or furnace as an example method of performing the thermal annealing step;

FIG. 6 is similar to FIG. 3 and illustrates an example where the thermal annealing step is performed using an annealing laser beam;

FIG. 7 is similar to FIG. 6 and illustrates an example where the annealing laser beam is defocused to cover more of the glass substrate than the focused annealing laser beam of FIG. 6;

FIG. 8 is similar to FIG. 3 and shows the initially formed glass bump being irradiated for a second time to increase its height from the post-anneal height H1′ to a second height H2;

FIG. 9 is a schematic diagram of an optical inspection system used to visually inspect the glass substrate for the presence or absence of stress associated with the glass bump;

FIG. 10 is similar to FIG. 9 and illustrates an example optical inspection system that utilizes an imaging detector, an image processor and a display to measure the glass substrate for the presence or absence of stress associated with the glass bump;

FIG. 11 plots experimental data of the change in refractive index Δn versus position (μm) for a glass substrate having a bump formed thereon for prior to annealing (solid line) and after annealing (dashed line); and

FIG. 12 is a schematic, cross-sectional view of an example glass substrate having a plurality of glass bumps formed thereon that constitute lens elements of a lens element array.

### DETAILED DESCRIPTION OF THE PREFERRED EMBODIMENTS

Reference is now be made in detail to the present preferred embodiments of the disclosure, examples of which are illustrated in the accompanying drawings. Whenever possible, the same reference numerals or symbols are used throughout the drawings to refer to the same or like parts.

In the discussion below, the “bump” is broadly understood to include any raised feature on the surface of a glass substrate caused by local heating and swelling of the substrate, including isolated bumps, groups or arrays of bumps having the same or different heights, one or more ridges, including ridges of varying heights and configurations (e.g., lines, concentric circles, squares and other shapes, etc.), and generally all variety of more complex surface features resulting from combinations of bumps, ridges, mesas, gratings and like raised features.

Also, the term “glass substrate” is intended to mean any type of glass material in any form, such as a glass plate, a glass block, a piece of glass having a curved surface such a lens, and generally any form of glass having a surface on which one or more glass bumps can be formed. An exemplary glass substrate is a glass plate having opposing parallel surfaces and this type of substrate is discussed below by way of example.

In addition, the “bump height” is measured from the locally flat surface of the glass substrate prior to bump formation.

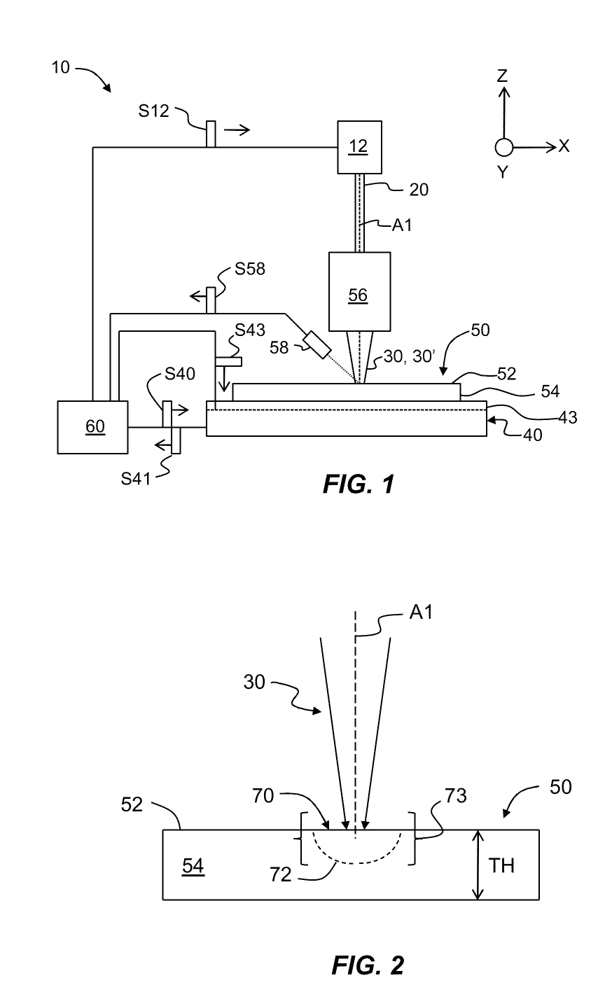

FIG. 1 is a schematic diagram of an example laser irradiation system 10 for forming bumps on glass and that can also be used for thermal annealing as explained below. Cartesian X-Y-Z coordinates are shown for the sake of reference, with the +Y-direction extending into the paper. Laser irradiation system 10 includes a laser 12 that generates an initial laser beam 20 along a system axis A1. Example lasers 12 include Nd:YAG lasers, Ar-ion lasers and near-infrared (NIR) fiber lasers such as those that operate at 810 nm and 1550 nm for example. In an example embodiment, laser beam 20 includes or more wavelengths ranging from 250 nm to 3,000 nm. Also in an example embodiment, laser 12 is a pulsed laser.

Laser irradiation system 10 also includes a movable support stage 40 movable in the X, Y and Z directions and configured to support a glass substrate 50 having an upper surface 52 and a glass body 54. Laser irradiation system 10 further includes an optical system 56 configured to receive initial laser beam 20 and form therefrom a focused laser beam 30 that is incident upon glass substrate surface 52 preferably at or near normal incidence. A temperature sensor 58 is operably arranged relative to glass substrate 50 to measure the localized temperature of glass substrate 52 when it is irradiated by bump-forming (“irradiating”) laser beam 30 or by an annealing laser beam 30′, as described below.

Laser irradiation system 10 also includes a controller 60 operably connected to and configured to control the operation of laser 12 and movable support stage 40. In an example embodiment, controller 60 is or includes a microcontroller, processor or computer. Laser 12 is controlled via the operation of a laser control signal S12 from controller 60. The position and motion of movable support stage 40 is controlled by a stage control signal S40 from controller 60, and a position/motion signal S41 is provided from the movable support stage to the controller. Position/motion signal S41 provides position and motion information to the controller and is used for substrate positioning and alignment. A temperature signal S56 representative of the measured glass temperature is provided by temperature sensor 56 to controller 60. Laser irradiation system 10 is used to carry out the methods of bump formation and optionally thermal annealing as described below.

FIG. 2 is a schematic close-up, cross-sectional diagram of glass substrate 50 and laser beam 30 incident thereon, illustrating an initial bump fabrication step in the method of forming bumps with increased bump height. Glass substrate 50 has a thickness TH. An example glass thickness TH is 0.5 mm to 6 mm thick. Glass substrate 50 is generally any glass type that locally expands upon being locally irradiated to form a glass bump. Example glass types for glass substrate 50 include glasses such as soda-lime, borosilicate, phosphor aluminosilicate, soda zinc silicate, and calcium aluminosilicate glasses.

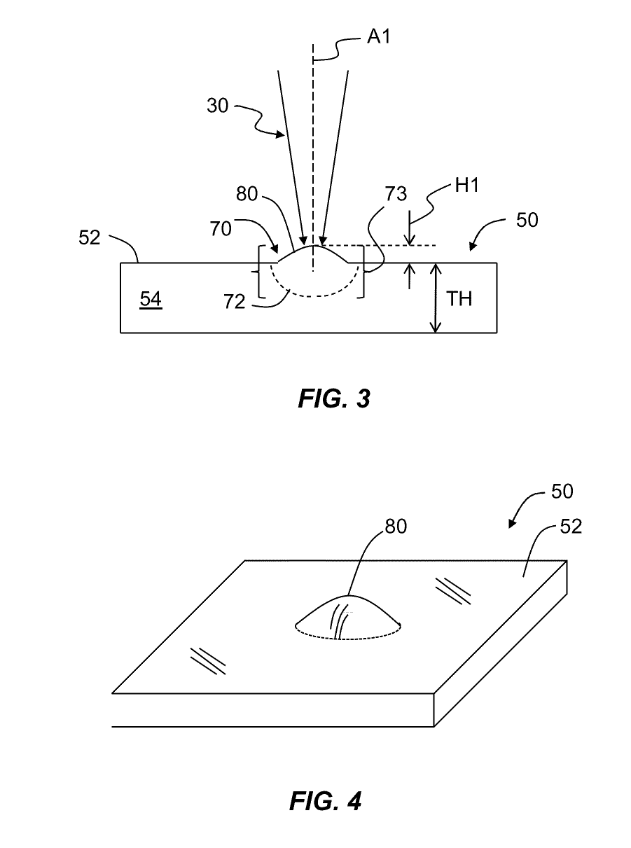

With reference to FIG. 2, a localized surface region 70 of glass surface 52 is irradiated with laser beam 30. At least some of the energy from laser beam 30 is locally absorbed in a localized volume region 72 within glass body 54 associated with the irradiated localized surface region 70. The localized surface region 70 and associated localized volume region 72 constitute an “irradiated portion” 73 of glass substrate 50. The absorbed energy heats the localized volume 72 and after an amount of time (typically 1 s to 2 s, depending on the type of glass, the power in laser beam 30, etc.), the localized irradiated portion 73 of glass body 54 swells, forming a bump 80 of height H1 on glass surface 52, as is shown in FIG. 3 and FIG. 4. The bump height H1 increases with laser pulse energy and at some point reaches a maximum height due to the aforementioned glass saturation effects. If the laser pulse energy is increased further, the bump height H1 is actually reduced because the glass starts to reflow.

Once bump 80 is formed, glass substrate 50 is thermally annealed. In one example embodiment, the thermal annealing reduces but does not entirely eliminate (relieve) the glass stress associated with the formation of bump 80. For example, the thermal annealing may be carried out so that most of the glass stress is removed but some measurable amount still remains. Thermal annealing to only partially remove glass stress may be desirable in situations where subsequent bump growth (i.e., re-growth) only needs to be slight or incremental. In another example embodiment, the thermal annealing relieves the glass stress, e.g., to removes the glass stress to the point where it no longer detectable using ordinary measurement means. Thermal annealing to relieve the glass stress is usually desirable when bump re-growth needs to be maximized. In one example embodiment, the entire glass substrate 50 is annealed while in another example embodiment just a portion of the glass substrate associated with bump 80 is annealed. In yet another example embodiment, a portion of glass substrate 50 larger than that associated with bump 80 but smaller than the entire glass substrate is annealed to mitigate thermal gradient effects, as described below.

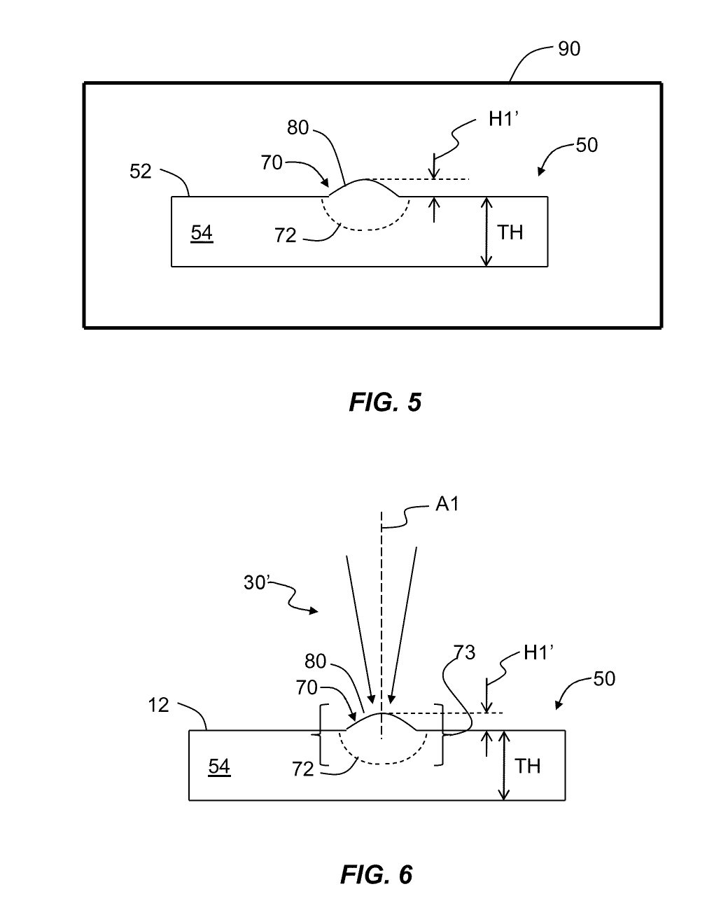

In an example embodiment as illustrated in FIG. 5, thermal annealing is carried out by placing glass substrate 50 in an oven or furnace 90. An example anneal time range is from about 1 hour to about 2 hours, and an example anneal temperature range is from about 530° C. to about 550° C. In some cases, the anneal changes height H1 to a height H1′, which may be slightly bigger or slightly smaller, e.g., by 1 μm to 2 μm (within a measurement accuracy of +1/−1 μm) than the pre-anneal height H1. In other cases the pre- and post-anneal heights remain the same, i.e., H1=H1′.

In an alternative annealing embodiment, an annealing laser beam 30′ is used to locally thermally anneal the irradiated portion 73, which now includes bump 80 and underlying volume region 72. With reference to FIG. 6 and also to FIG. 1, after irradiation with “irradiating” laser beam 30 to form bump 80, the laser power is reduced via laser control signal S12 to form an annealing laser beam 30′ that sustains the glass temperature of bump 80 and volume region 72 at the desired annealing temperature, which is monitored by temperature sensor 58. Temperature signal S58 provides feedback to controller 60 for adjusting or maintaining the laser power in annealing laser beam 30′ to keep the glass temperature constant.

In another alternative annealing embodiment, the same basic approach is used to provide a specific temperature profile on bump 80 during processing. After exposure, rather than immediately turning off laser beam 30, the laser power is lowered to provide heating slightly above the annealing temperature (e.g., 10° C. to 20° C. above the annealing temperature). The laser power is then slowly reduced, e.g., over an interval of 10 seconds to 60 seconds. This annealing method results in reduced stress in the cooled glass and requires less time to achieve annealing.

In another example annealing embodiment, glass substrate 50 is supported on a hot plate 43 (see FIG. 1), whose temperature is controlled by controller 60. In FIG. 1, hot plate 43 is shown by way of example as incorporated into stage 40. In an example embodiment, controller 60 uses control signals S43 to cause hot plate 43 to have different temperatures during processing to form bump 80. In one approach, a lower temperature is used during laser exposure, a higher temperature is used during annealing, and then a lower temperature is used when re-growing bump 80 with a subsequent exposure. This embodiment has the advantage that it avoids the need to realign laser beam 30 with bump 80 after the annealing step.

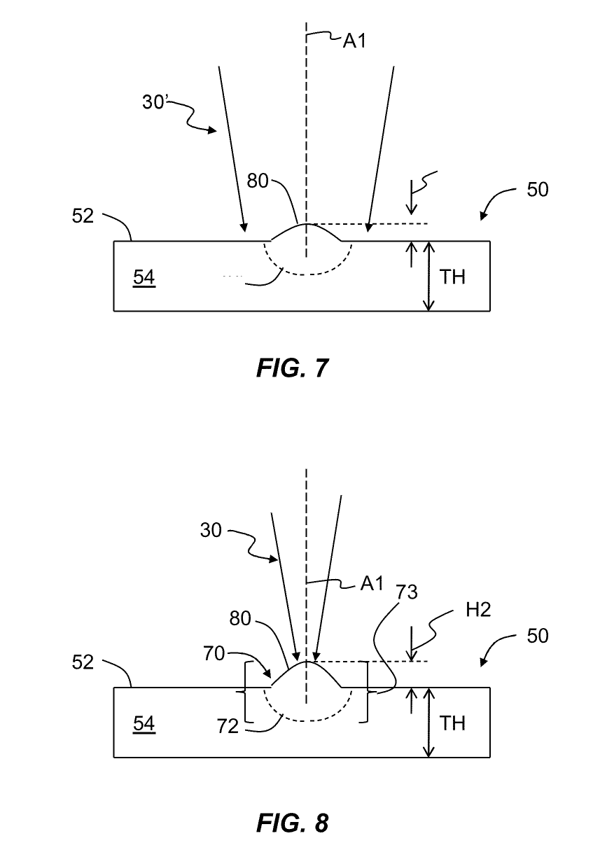

If a larger area/volume of glass substrate 50 has to be heated in order to avoid steep temperature gradients during thermal annealing, then in an example embodiment annealing laser beam 30′ is defocused, as shown in FIG. 7. This defocusing can be accomplished by adjusting (i.e., defocusing) optical system 56 and/or by moving movable stage 40 sufficiently far in the +Z or −Z directions.

After glass substrate 50 is thermally annealed, then with reference to FIG. 8, bump 80 is re-irradiated with either the same irradiating laser beam 30, or another irradiating laser beam (e.g., a laser beam from a different laser 12 having a different wavelength) to cause “regrowth” of the bump, i.e., the bump height increases from height H1′ to a height H2, where H2>H1, H1′.

In an example embodiment, the steps of irradiating and thermally annealing are repeated multiple times to increase the bump height multiple times until a desired or acceptable final bump height is reached, or if the additional annealing and irradiation provides a diminishing increase in the bump height.

TABLE 1 below presents data taken for the bump-forming method of the present disclosure that employs two annealing steps and three irradiation steps.

TABLE 1
BUMP FORMATION EXPERIMENTAL DATA

| | PE1 | H1 | H1′ | PE2 | H2 | PE3 | H3 |
|---|---|---|---|---|---|---|---|
| N | (J) | (μm) | (μm) | (J) | (μm) | (J) | (μm) |
| 1 | 19.8 | 102.4 | 103.1 | 24.8 | 140.5 | 24.8 | 168.2 |
| 2 | 14.5 | 94.6 | 94.8 | 24.8 | 134.7 | 24.8 | 159.4 |
| 3 | 19.8 | 102.4 | 103.8 | 24.8 | 153.2 | 24.8 | 170.9 |
| 4 | 25.8 | 85.1 | 82.1 | 25.8 | 170.9 | 25.8 | 193.6 |
| 5 | 25.8 | 116.8 | 116.7 | 25.8 | 149.2 | 25.8 | 176.6 |
| 6 | 25.8 | 88.1 | 84.9 | 25.8 | 134.4 | 25.8 | 165.4 |
| 7 | 25.8 | 106.5 | 106.2 | 25.8 | 141.3 | 25.8 | 169.6 |
| 8 | 21.8 | 70.9 | 66.6 | 25.8 | 95.3 | 21.8 | 117.2 |

The first column represents the sample or bump number N. The second column indicates the pulse energy PE1 in joules (J) for the first irradiation step. The third column indicates the initial bump height H1 as a result of the first irradiation step. The fourth column represents the bump height H1′ after the first annealing step. The fifth column represents the pulse energy PE2 for the second irradiation of the bump. The sixth column is the bump height H2 after the second irradiation step. The seventh column is the pulse energy PE3 for the third irradiation of the bump after having performed the second annealing step. The eighth column is the final height H3 after the third irradiation step.

The first anneal was performed for 1 hour at 530° C. The second anneal was performed at 550° C. for 1 hour because of the higher fictive temperature in the laser-exposed glass substrate. A small box furnace 90 was used to carry out the thermal annealing steps. The data represented in TABLE 1 were generated using a borosilicate glass substrate doped with cobalt and having a glass thickness TH of 2 mm. The initial maximum bump height H1 due to glass saturation effects was about 114 μm to about 116 μm, with the variation over this range due ostensibly to glass property variations. Laser beam 30 was generated using a 1550-nm single-mode fiber laser 12. The difference in heights using the same pulse energy is due to different focusing conditions of laser beam 30.

The data of TABLE 1 indicate that a substantial increase in bump height over the initial bump height H1 is achieved by annealing the glass and re-irradiating the bump. The re-irradiation need not have the same energy or even use the same laser beam 30 as the initial laser beam. In the case of bump number N=4, the initial bump height H1=85.1 μm was increase to bump height H3=193.6 μm, an increase of over 127% from the original bump height H1.

Comparison of the bump heights H1 and H1′ in TABLE 1 shows that the annealing step does not significantly affect the bump height. The criterion used for a successful annealing cycle was the substantial absence of stress within bump 80 and in the volume region 72 of glass substrate 50 associated therewith.

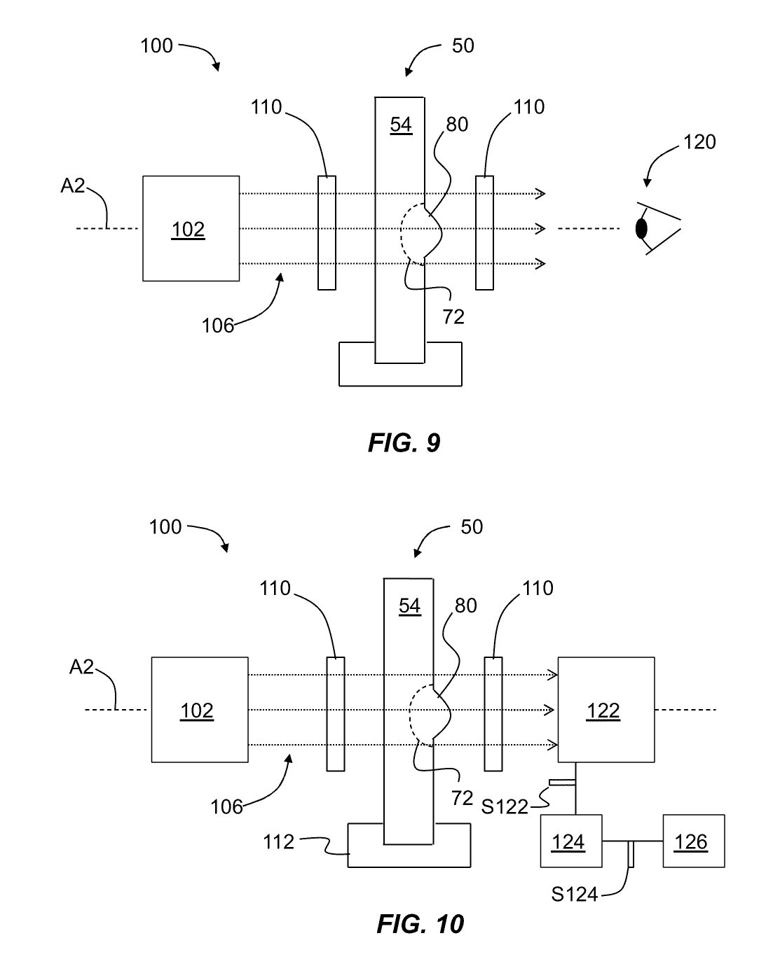

Stress measurement in glass substrate 50 is accomplished in one example by using standard optical instruments that measure birefringence. The absence of birefringence is a preferred criterion for establishing that there is no stress in glass substrate 50. FIG. 9 is a schematic diagram of an example optical inspection system 100 for visually assessing the presence or absence of stress in glass substrate 50 associated with bump 80. Optical inspection system 100 includes a light source 102 that emits light 106 along an axis A2. In an example embodiment, light source 102 is a white light or multi-wavelength light source. First and second polarizers 110 are arranged along axis A2, with the polarizer closest to light source 102 being the “upstream” polarizer and the polarizer farthest from the light source being the “downstream” polarizer.

Glass substrate 50 with bump 80 is supported by a substrate support member 112 and is disposed between polarizers 110 so that bump 80 lies along axis A2. Polarizers 110 are “cross-polarized” so that in the absence of any polarization rotation, an observer 120 adjacent and downstream of the downstream polarizer sees no light 106 passing through the downstream polarizer. If the glass in glass bump 80 and/or underlying volume region 72 contains stress, then the associated stress birefringence causes polarization rotation of light 106 so that some of this light will pass through the downstream polarizer 110 and be visible to observer 120. On the other hand, if the annealing step removes substantially all of the glass stress in bump 80 and in underlying volume region 72, then substantially no light 106 will be visible to observer 120.

FIG. 7 is a schematic diagram of an example optical inspection system 100 similar to that of FIG. 6, but that replaces observer 120 with an imaging detector 122 such as a CCD camera. Imaging detector 122 is electrically connected to an image processor 124, which in turn is electrically connected to a display 126. Imaging detector 122 detects light passing through the downstream polarizer 106 and forms a digital image of the detected light. The digital image of the detected light is embodied in a raw digital detector signal S122 provided to image processor 124. Image processor 124 is configured to process the raw digital image embodied in raw detector signal 122 in a manner that allows for a precise measure or quantification of the amount of light transmitted by downstream polarizer 110. Example image processing by image processor 124 includes filtering, noise reduction, generating false-color images, pixel weighting, pixel calibration, threshold detection, etc.

Image processor 124 then generates a processed image signal S124 and provides this signal to display 126, which displays the processed image. In an example embodiment, image processor 124 simply transmits the raw digital image associated with raw detector signal S122 to display 126 for direct display of the associated raw image. The use of imaging detector 122 and image processor 124 provides a more sensitive method of measuring transmitted light 106 and thus the amount of stress in glass substrate 50.

TABLE 1 indicates that the re-irradiation of bumps 80 enabled additional growth to a bump height H2 that was an average of 40 μm greater than the initial bump height H1. The re-growth effect is explained by the annealing process substantially restoring the glass to its original, pre-exposed state and effectively transforming the laser-induced bump growth into an additive process. Although the experimental data of TABLE 1 involve solitary bumps, the annealing approach is generally applicable to the aforementioned types of generalized bumps because of the general applicability of the glass-swelling mechanism.

In an example embodiment, the shape of a particular bump 80 is modified by carrying out the post-anneal irradiation under different conditions than the initial irradiation, such as different degrees of focusing, or with a laser beam 30 that is offset from the previous irradiation position, or with a different laser beam having a different wavelength and/or pulse energy. This approach allows for creating complex bump shapes with added functionality that are otherwise difficult to achieve using a single irradiation step.

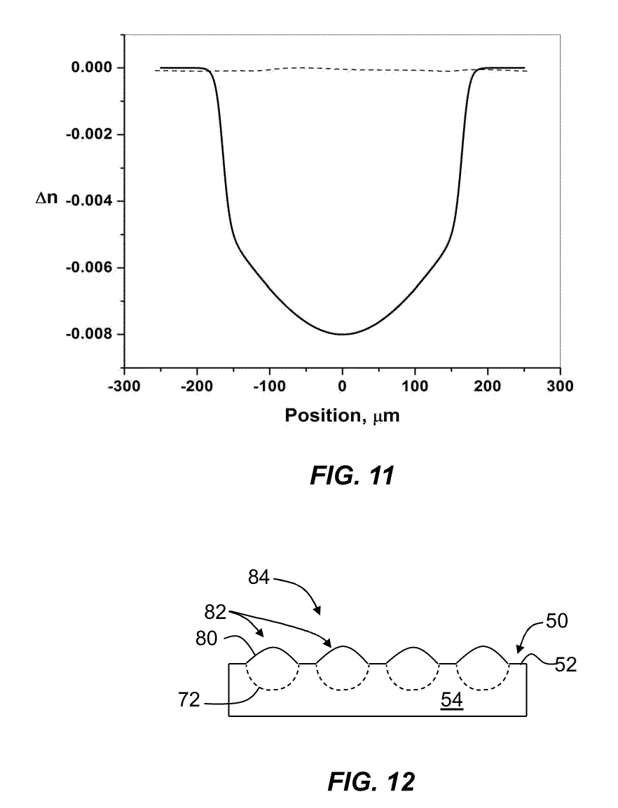

FIG. 11 plots experimental data of the change in refractive index Δn versus position (μm) for a glass substrate 50 having a bump 80 formed thereon both prior to annealing (solid line) and after annealing (dashed line). The plot of FIG. 11 illustrates that, in addition to removing stress, the annealing step also substantially erases the decrease in the refractive index generally observed following laser irradiation for bump formation. The refractive index in glass body 54 is usually linearly related to its density. Restoring the refractive index to essentially no change from the original glass state indicates that the glass density was returned to at or near its original value by the annealing step. It is believed that the post-annealing ability to increase the height of a previously formed bump beyond the glass saturation limit is because the post-annealed glass has essentially the same structure as the original glass.

The ability to reduce or relieve the stress-induced birefringence in and under bump 80 (i.e., in irradiated portion 73) grown by laser irradiation represents an important improvement over previous bump-forming methods. For example, with reference to FIG. 12, it allows for the formation of one or more bumps 80 for use as one or more lens element 82 (e.g., a lens element array 84) with virtually no change in refractive index below the one or more lens elements, i.e., in the associated volume region(s) 72. Further, a reduced thickness TH for glass substrate 50 can be used to grow much taller bumps than previously possible. As discussed above, the glass saturation effect limits the initial bump heights to approximately 10% to 13% of the glass thickness TH for those glasses displaying significant swelling. The methods described herein allows for bump heights of greater than 13% of the glass thickness TH, and in some cases between 15% and 25% of the glass thickness. The methods described herein also allow for increasing the initial bump height in some cases by up to 100%, in other cases by up to 200%, and in certain cases by up to 250%.

The bump growing methods of the present disclosure allow for greater flexibility in creating surface features on glass of different scales and magnitudes. Applications such as spacers, microlenses, and the like will benefit from the ability to laser-grow larger surface features on glass. As discussed above, the benefits of being able to grow a single bump, perform thermal annealing, and then grow the bump further is not constrained to forming a single, spherical bump-like feature. The configuration of the original surface feature may be modified such that a new, smaller bump or surface feature is grown on top of the original surface feature. For example, the methods of the present disclosure enable augmenting a previously formed spherical bump to an aspherical one for applications involving aspheric lenses and aspherical lens arrays, such as the lens elements 82 and lens element array 84 shown in FIG. 12, by changing the beam focus, offsetting the beam, or both, and by other like means.

It will be apparent to those skilled in the art that various modifications to the preferred embodiment of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A method of forming at least one bump on a surface of a glass substrate, comprising:
a) performing a local irradiation of the glass substrate to form the at least one bump having an initial height;
b) thermally annealing at least a portion of the glass substrate to a temperature and for a duration that reduces or relieves laser-induced stress in the glass substrate; and
c) increasing the bump height by irradiating the bump.

2. The method of claim 1, further comprising repeating acts b) and c) multiple times.

3. The method of claim 1, wherein the glass substrate comprises a glass plate having parallel opposing surfaces and a thickness of between 0.5 mm and 6 mm.

4. The method of claim 1, wherein the glass substrate has a thickness and further comprising forming a final bump height that is between 15% and 25% of the glass thickness.

5. The method of claim 1, further comprising increasing the bump height from the initial bump height by up to 250%.

6. The method of claim 1, wherein the thermal annealing is performed by one of:
heating the glass substrate using an oven, a furnace or a hotplate; and
locally irradiating the at least one bump using an annealing laser beam.

7. A method of forming a bump a glass substrate having a surface and a body portion, comprising:
performing a first irradiation of a portion of the glass substrate to form the bump in the glass surface, with the bump having a first height;
performing a first thermal annealing of the first irradiated portion; and
performing a second irradiation of at least part of the first irradiated portion to increase the height of the bump to a second height greater than the first height.

8. The method of claim 7, further comprising thermally annealing the irradiated portion by at least one of:
heating the glass substrate using an oven, a furnace or a hot plate; and
irradiating at least the first irradiated portion with an annealing laser beam.

9. The method of claim 7, further comprising:
performing a second thermal annealing of the second irradiated portion; and
performing a third irradiation of at least part of the second irradiated portion to increase the height of the bump to a third height greater than the second height.

10. The method of claim 7, further comprising performing the first irradiation with a pulsed laser beam having an infrared wavelength.

11. The method of claim 7, wherein the first irradiation introduces glass stress in the first irradiated portion, and further comprising:
establishing a substantial absence of glass stress in the first irradiated portion after the first thermal annealing but prior to performing the second irradiation.

12. The method of claim 11, wherein said establishing the substantial absence of glass stress further comprises measuring or observing the substantial presence or substantial absence of stress birefringence in the first irradiated portion.

13. The method of claim 11, including measuring a temperature of the first irradiated portion during at least one of the first irradiation, the first thermal annealing and the second irradiation.

14. The method of claim 7, wherein the first and subsequent irradiations are performed with a laser beam.

15. The method of claim 7, wherein the glass substrate has a thickness and further comprising forming the second bump height to be between 15% and 25% of the glass thickness.

16. A method of forming at least one bump on a surface of a glass substrate, comprising:
irradiating a first portion of the glass substrate with a first laser beam to form at least one bump having a first height H1;
thermally annealing at least a portion of the glass substrate to reduce or relieve glass stress formed during said irradiating; and
irradiating the at least one bump with a second laser beam to increase the bump height to a second height H2>H1.

17. The method of claim 16, wherein the first height H1 is a maximum height determined by glass saturation effects caused by irradiating the first portion.

18. The method of claim 16, including increasing the bump height by up to 250%.

19. The method of claim 16, wherein the first and second laser beams are the same laser beam.

20. The method of claim 16, wherein the first and second laser beams have a wavelength in the range between 250 nm and 3,000 nm.
